(19) United States
(12) Patent Application Publication
(10) Pub. No.: US 2023/0050082 A1
(43) Pub. Date: Feb. 16, 2023

(54) METHODS, DEVICES, AND MEDIUM FOR COMMUNICATION

(71) Applicant: NEC CORPORATION, Tokyo (JP)

(72) Inventor: Gang WANG, Beijin (CN)

(73) Assignee: NEC CORPORATION, Tokyo (JP)

(21) Appl. No.: 17/789,056

(22) PCT Filed: Dec. 31, 2019
(86) PCT No.: PCT/CN2019/130571

§ 371 Date: Jun. 24, 2022

(51) Int. Cl. H04W 52/02; H04W 72/12

(52) U.S. Cl. CPC H04W 52/0229; H04W 72/1284

(57) ABSTRACT

Embodiments of the present disclosure relate to methods, devices, and medium for communication. According to embodiments of the present disclosure, the terminal device transmits the assistant information to the network device. The assistant information indicates preferences of the terminal device. The network device determines configuration information based on the assistant information and transmits the configuration information to the terminal device. In this way, the configuration is suitable to the terminal device.

### TECHNICAL FIELD

Embodiments of the present disclosure generally relate to the field of telecommunication, and in particular, to methods, devices, and medium for communication.

### BACKGROUND

Communication technologies have been developed. In some situations, requirement of power consumption at the terminal device may be strict. For example, if a terminal device, such as a sensor, is at remote area, batteries of the terminal device cannot be changed frequently. Thus, technologies on saving power need to be further studied.

### SUMMARY

In general, example embodiments of the present disclosure provide a solution of assistant information for terminal devices and network devices.

In a first aspect, there is provided a method for communication. The method comprises determining, at a terminal device, assistant information indicating one or more of: a measurement of a reference signal, a preference of a bandwidth part, a preference of paging configuration, a preference of inactive semi persistent scheduling, a preference of mobility, a preference of acquisition for a system information block, a preference of an uplink bit rate, a preference for a measurement event configuration, and a traffic type of the terminal device. The method also comprises transmitting the assistant information to a network device.

In a second aspect, there is provided a method for communication. The method receiving, at a network device and from a terminal device, assistant information indicating one or more of: a measurement of a reference signal, a preference of a bandwidth part, a preference of paging configuration, a preference of inactive semi persistent scheduling, a preference of mobility, a preference of acquisition for a system information block, a preference of an uplink bit rate, a preference for a measurement event configuration, and a traffic type of the terminal device. The method also comprises generating, based on the assistant information, configuration information for communication between the terminal device and the network device. The method further comprises transmitting the configuration information to the terminal device.

In a third aspect, there is provided a terminal device. The terminal device comprises a processing unit; and a memory coupled to the processing unit and storing instructions thereon, the instructions, when executed by the processing unit, causing the terminal device to perform determining assistant information indicating one or more of: a measurement of a reference signal, a preference of a bandwidth part, a preference of paging configuration, a preference of inactive semi persistent scheduling, a preference of mobility, a preference of acquisition for a system information block, a preference of an uplink bit rate, a preference for a measurement event configuration, and a traffic type of the terminal device; and transmitting the assistant information to a network device.

In a fourth aspect, there is provided a network device. The network device comprises a processing unit; and a memory coupled to the processing unit and storing instructions thereon, the instructions, when executed by the processing unit, causing the network device to perform: receiving, and from a terminal device, assistant information indicating one or more of: a measurement of a reference signal, a preference of a bandwidth part, a preference of paging configuration, a preference of inactive semi persistent scheduling, a preference of mobility, a preference of acquisition for a system information block, a preference of an uplink bit rate, a preference for a measurement event configuration, and a traffic type of the terminal device; generating, based on the assistant information, configuration information for communication between the terminal device and the network device; and transmitting the configuration information to the terminal device.

In a fifth aspect, there is provided a computer readable medium having instructions stored thereon, the instructions, when executed on at least one processor, causing the at least one processor to carry out the method according to the first aspect.

In a sixth aspect, there is provided a computer readable medium having instructions stored thereon, the instructions, when executed on at least one processor, causing the at least one processor to carry out the method according to the second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 is a signaling chart illustrating a process according to an embodiment of the present disclosure;

FIG. 3 is a flowchart of an example method in accordance with an embodiment of the present disclosure;

FIG. 4 is a flowchart of an example method in accordance with an embodiment of the present disclosure; and

FIG. 5 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. In the following description, the terms “terminal device”, “communication device”, “terminal”, “user equipment” and “UE” may be used interchangeably.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.55G, the third generation (3G), the fourth generation (4G), 4.5G, the fifth generation (5G) communication protocols. The techniques described herein may be used for the wireless networks and radio technologies mentioned above as well as other wireless networks and radio technologies.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, technologies on saving power need to be further studied. In conventional technologies, the terminal device may generate support information for power saving. However, in the conventional technologies, the network device may not determine the configuration based on the support information.

According to embodiments of the present disclosure, the terminal device transmits the assistant information to the network device. The assistant information indicates preferences of the terminal device. The network device determines configuration information based on the assistant information and transmits the configuration information to the terminal device. In this way, the configuration is suitable to the terminal device.

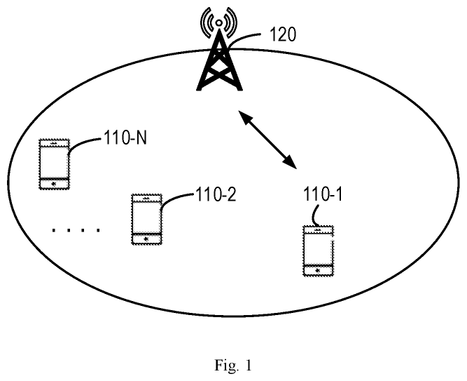

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The communication system 100 further comprises a network device 12.

In the communication system 100, the terminal device 110 and the network device 120 can communicate data and control information to each other. The number of devices shown in FIG. 1 is given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

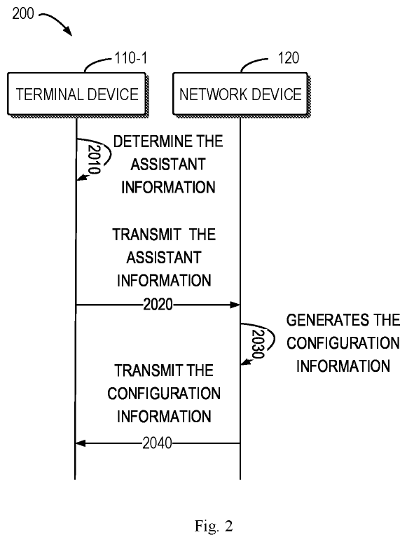

Embodiments of the present disclosure will be described in detail below. Reference is first made to FIG. 2, which shows a signaling chart illustrating interactions between a terminal device and network devices according to some example embodiments of the present disclosure. Only for the purpose of discussion, the process 200 will be described with reference to FIG. 1. The process 200 may involve the terminal device 110-1 and the network device 120 in FIG. 1.

The terminal device 110-1 determines 2010 the assistant information of the terminal device 110-1. The assistant information indicates one or more of a measurement of a reference signal, a preference of bandwidth part, a preference of paging configuration, a preference of inactive semi persistent scheduling, a preference of mobility, a preference of acquisition for system information block, a preference for an uplink bit rate, a preference for measurement event configuration, a traffic type of the terminal device.

In some embodiment, if the terminal device 110-1 is in the radio resource control (RRC)_IDLE state, the terminal device 110-1 may perform measurements of the cell where the terminal device 110-1 locates. For example, if the serving cell's evaluation result is as follows, the terminal device 110-1 may perform the measurement.

Srxlev>0 (1)

Squal>0 (2)

where the parameter “Srxlev” represents the cell selection receiving (RX) level value and the parameter “Squal” represents the cell selection quality value.

In an example embodiment, the parameter “Srxlev” and the parameter “Squal” may be represented as follows:

Srxlev=Qᵣₓₗₑᵥₘₑₐₛ−(Qᵣₓₗₑᵥₘᵢₙ+Q_{rxlevminoffset})−P_{compensation}−Q_{offsettemp} (3)

where the parameter “Qᵣₓₗₑᵥₘₑₐₛ” represents measured cell RX value, for the reference signal received power (RSRP), the parameter “Qᵣₓₗₑᵥₘᵢₙ” represents the minimum required RX level in the cell, the parameter “Q_{rxlevminoffset}” represents the offset to the signaled Qᵣₓₗₑᵥₘᵢₙ, the parameter “P_{compensation}” represents max (UE_TXPWR_MAX_RACH-P_MAX, 0), the “UE_TXPWR_MAX_RACH-P_MAX” represents the maximum transmitting (TX) power level a terminal device uses when accessing the cell on random access channel (RACH), the “P_MAX” represents the maximum RF output power of the terminal device, and the parameter “Q_{offsettemp}” represents the offset temporarily applied to the cell.

Squal=Q_{qualmeas}−(Q_{qualmin}+Q_{qualminoffset})−Q_{offsettemp} (4)

where the parameter “Q_{qualmeas}” represents the measured cell quality value, the parameter “Q_{qualmun}” represents the minimum required quality level in the cell, the parameter “Q_{qualminoffset}” represents the offset to the signaled Qᵤₐₗᵢₘᵢₙ, and the parameter “Q_{offsettemp}” represents the offset temporarily applied to the cell.

In some embodiments, the terminal device 110-1 may measure the RSRP. Alternatively or in addition, the terminal device 110-1 may measure the RSRQ. The terminal device 110-1 may generate the measurement of the reference signal comprising the RSRP and/or RSRQ. The measurement may be used by the network device 120 to identity the cell edge.

In an example embodiment, the terminal device 110-1 may be configured with more than one bandwidth part (BWP). The terminal device 110-1 may determine its preference of the BWP and generate the assistant information indicating the preference of the BWP. In some embodiments, the terminal device 110-1 may determine the BWP for uplink and/or downlink communication. In some embodiments, part of the legacy BWP can be indicated. For example, the terminal device 110-1 may be configured the BWPs as Table 1 below. It should be noted that the BWPs shown in Table 1 are only examples not limitations.

TABLE 1

| | | |
|---|---|---|
| BWP Identity | Bandwidth | Subcarrier Spacing (SCS) |

| | | | |
|---|---|---|---|
| 1 | 40 | MHz | 15 kHz |
| 2 | 10 | MHz | 15 kHz |
| 3 | 20 | MHz | 60 kHz |
| 4 | 5 | MHz | 15 kHz |
| 5 | 1.4 | MHz | 15 kHz |

For example, the terminal device 110-1 may determine the identity of the BWP (for example, BWP 1) and generate the preference of the BWP indicating the identity. The terminal device 110-1 may report the preferred BWP identity in the assistant information as the activated BWP. In this way, the power of the terminal device can be saved.

In other embodiments, the terminal device 110-1 may determine its preferred paging configuration. In this way, the power of the terminal device can be saved. For example, the terminal device 110-1 may determine the paging cycle based on the power consumption of the terminal device 110-1. The terminal device 110-1 may generate the preference of paging configuration comprising the paging cycle. For example, the paging cycle may be one of rf32, rf64, rf128, rf256, rf512, rf1024, rf2048, or, rf4096. Table 2 below shows an example paging configuration. It should be noted that the paging configuration shown in Table 2 is only an example not limitation.

TABLE 2

| PCCH-Config ::= | | SEQUENCE { |
|---|---|---|
| defaultPagingCycle | | PagingCycle, |
| nAndPagingFrameOffset | | CHOICE { |
| | oneT | NULL, |
| | halfT | INTEGER (0..1), |
| | quarterT | INTEGER (0..3), |
| | oneEighthT | INTEGER (0..7), |
| | oneSixteenthT | INTEGER (0..15) |

},

| | |
|---|---|
| ns | ENUMERATED {four, two, one}, |
| firstPDCCH-MonitoringOccasionOfPO | CHOICE { |

sCS15KHZoneT

SEQUENCE (SIZE (1..maxPO-perPF)) OF INTEGER (0..139),

sCS30KHZoneT-SCS15KHZhalfT

SEQUENCE (SIZE (1..maxPO-perPF)) OF INTEGER (0..279),

sCS60KHZoneT-SCS30KHZhalfT-SCS15KHZquarterT

SEQUENCE (SIZE (1..maxPO-perPF)) OF INTEGER (0..559),
sCS120KHZoneT-SCS60KHZhalfT-SCS30KHZquarterT-SCS15KHZoneEighthT
SEQUENCE (SIZE (1..maxPO-perPF)) OF INTEGER (0..1119),
sCS120KHZhalfT-SCS60KHZquarterT-SCS30KHZoneEighthT-SCS15KHZoneSixteenthT
SEQUENCE (SIZE (1..maxPO-perPF)) OF INTEGER (0..2239),

sCS120KHZquarterT-SCS60KHZoneEighthT-SCS30KHZoneSixteenthT

SEQUENCE (SIZE (1..maxPO-perPF)) OF INTEGER (0..4479),

sCS120KHZoneEighthT-SCS60KHZoneSixteenthT

SEQUENCE (SIZE (1..maxPO-perPF)) OF INTEGER (0..8959),

sCS120KHZoneSixteenthT

SEQUENCE (SIZE (1..maxPO-perPF)) OF INTEGER (0..17919)

| | | |
|---|---|---|
| } | OPTIONAL, | -- Need R |

...

}

In some embodiments, the terminal device 110-1 may determine a data rate of the terminal device 110-1 and generate the preference of inactive semi persistent scheduling (SPS) comprising the data rate of the terminal device. In this way, the SPS can be configured more suitable. For example, for the video surveillance of which data rate is fixed, the terminal device 110-1 may report the assistant information indicating the data rate which can be used to allocate radio resources. In this way, the dedicated radio bearer (DRB) can be configured more precisely.

In some embodiment, the terminal device 110-1 may determine the mobility preference and generate the assistant information indicating the mobility preference. If the terminal device 110-1 is a fixed location device, the terminal device 110-1 may generate the assistant information to indicate that the terminal device 110-1 is fixed. If the terminal device 110-1 is embedded with global navigation satellite system (GNSS), the terminal device 110-1 may generate the assistant information indicating its fixed location. If the terminal device 110-1 is a fast speed device, the terminal device 110-1 may generate the assistant information to indicate that the terminal device 110-1 is the fast speed device. In addition, the terminal device 110-2 may generate the assistant information indicating its speed. The mobility preference may be used for determining radio network area (RNA) configuration. For example, if the terminal device 110-1 is fast moving, the terminal device 110-1 may obtain more than one RNA list from the network device 120. The terminal device 110-1 may connect with other network devices based on the RNA list. Details of configuring the RNA will be described later. In this way, the RNA can be configured precisely.

In some embodiments, the terminal device 110-1 may determine the number of system information blocks (SIB) based on a type of the terminal device 110-1 and generate the preference of acquisition for the SIB comprising the required number of s SIBs. In some embodiments, new SIB is introduced for new radio (NR) light. There may be multiple SIBs for multiple NR light devices type and the SIB size may be limited.

In some embodiments, the terminal device 110-1 may determine an uplink bit rate. The terminal device 110-1 may generate the assistant information indicating the preference of the uplink bit rate.

In an example embodiment, the terminal device 110-1 may determine a type of measurement event and determine measurement parameters for the type of measurement event. The terminal device 110-1 may generate the assistant information indicating the preference of measurement event configuration which comprises the type of the measurement event and the measurement parameters. Table 3 below shows example measurement events and parameters. It should be noted that the measurement events and parameters shown in Table 3 are only examples not limitations.

TABLE 3

| Measurement Event | Parameters |
|---|---|
| A1 measurement event | Hys is the hysteresis parameter for this |
| | event (i.e. hysteresis as defined within |
| | reportConfigNR for this event). |
| | Thresh is the threshold parameter for |
| | this event (i.e. a1-Threshold as defined |
| | within reportConfigNR for this event). |
| A2 measurement event | Hys is the hysteresis parameter for this |
| | event (i.e. hysteresis as defined within |
| | reportConfigNR for this event). |
| | Thresh is the threshold parameter for |
| | this event (i.e. a2-Threshold as defined |
| | within reportConfigNR for this event). |
| A3 measurement event | Ofn is the measurement object specific |
| | offset of the reference signal of the |
| | neighbour cell (i.e. offsetMO as defined |
| | within measObjectNR corresponding to the |
| | neighbour cell). |
| | Ocn is the cell specific offset of the |
| | neighbour cell (i.e. cellIndividualOffset as |
| | defined within measObjectNR |
| | corresponding to the frequency of the |
| | neighbour cell), and set to zero if not |
| | configured for the neighbour cell. |
| | Ofp is the measurement object specific |
| | offset of the SpCell (i.e. offsetMO as defined |
| | within measObjectNR corresponding to the |
| | SpCell). |
| | Ocp is the cell specific offset of the |
| | SpCell (i.e. cellIndividualOffset as defined |
| | within measObjectNR corresponding to the |
| | SpCell), and is set to zero if not configured |
| | for the SpCell. |
| | Hys is the hysteresis parameter for this |
| | event (i.e. hysteresis as defined within |
| | reportConfigNR for this event). |
| | Off is the offset parameter for this event (i.e. |
| | a3-Offset as defined within reportConfigNR |
| | for this event) |
| A4 measurement event | Ofn is the measurement object specific |
| | offset of the reference signal of the |
| | neighbour cell (i.e. offsetMO as defined |
| | within measObjectNR corresponding to the |
| | neighbour cell). |
| | Ocn is the cell specific offset of the |
| | neighbour cell (i.e. cellIndividualOffset as |
| | defined within measObjectNR |
| | corresponding to the frequency of the |
| | neighbour cell), and set to zero if not |
| | configured for the neighbour cell. |
| | Ocp is the cell specific offset of the |
| | SpCell (i.e. cellIndividualOffset as defined |
| | within measObjectNR corresponding to the |
| | SpCell), and is set to zero if not configured |
| | for the SpCell. |
| | Hys is the hysteresis parameter for this |
| | event (i.e. hysteresis as defined within |
| | reportConfigNR for this event). |
| | Off is the offset parameter for this event (i.e. |
| | a3-Offset as defined within reportConfigNR |
| | for this event). |
| A5 measurement event | Ofn is the measurement object specific |
| | offset of the neighbour cell (i.e. offsetMO as |
| | defined within measObjectNR |
| | corresponding to the neighbour cell). |
| | Ocn is the cell specific offset of the |
| | neighbour cell (i.e. cellIndividualOffset as |
| | defined within measObjectNR |
| | corresponding to the neighbour cell), and set |
| | to zero if not configured for the neighbour |
| | cell. |
| | Hys is the hysteresis parameter for this |
| | event (i.e. hysteresis as defined within |
| | reportConfigNR for this event). |
| | Thresh1 is the threshold parameter for |
| | this event (i.e. a5-Threshold1 as defined |
| | within reportConfigNR for this event). |
| | Thresh2 is the threshold parameter for this |
| | event (i.e. a5-Threshold2 as defined within |
| | reportConfigNR for this event) |
| A6 measurement event | Ocn is the cell specific offset of the |
| | neighbour cell (i.e. cellIndividualOffset as |
| | defined within the associated |
| | measObjectNR), and set to zero if not |
| | configured for the neighbour cell. |
| | Ms is the measurement result of the |
| | serving cell, not taking into account any |
| | offsets. |
| | Ocs is the cell specific offset of the |
| | serving cell (i.e. cellIndividualOffset as |
| | defined within the associated |
| | measObjectNR), and is set to zero if not |
| | configured for the serving cell. |
| | Hys is the hysteresis parameter for this |
| | event (i.e. hysteresis as defined within |
| | reportConfigNR for this event). |
| | Off is the offset parameter for this |
| | event (i.e. a6-Offset as defined within |
| | reportConfigNR for this event). |

In some embodiments, the terminal device 110-1 may determine the traffic type of the terminal device 110-1 and determine a modulation and coding scheme (MCS) corresponding to the traffic type of the terminal device 110-1. The terminal device 110-1 may generate the assistant information indicating the MCS and the traffic type. For example, the traffic type may be video surveillance, wearable devices and the like. The mapping information between the MCS and the traffic type may be pre-configured to the terminal device 110-1 and/or the network device 120. Alternatively or in addition, the mapping information between the data rate and the traffic type may be pre-configured to the terminal device 110-1 and/or the network device 120.

The terminal device 110-1 transmits 2020 the assistant information to the network device 120. In some embodiments, if the assistant information is updated, the terminal device 110-1 may transmit the assistant information to the network device 120. For example, if the measured RSRP is changed, the terminal device 110-1 may update the assistant information and transmit the updated assistant information. In some embodiments, the assistant information may be transmitted in RRC signaling.

The network device 120 generates 2030 the configuration information based on the assistant information. In some embodiments, the network device 120 may obtain the measurement of the reference signal from the assistant information. The measurement of the reference signal may comprise RSRP or RSRQ. The network device 120 may identify the cell edge based on the measurement of the reference signal. The network device 120 may generate the configuration information indicating the relay terminal device adjacent to the cell edge. For example, the network device 120 may configure the cell edge terminal device to be the relay terminal device.

In an example embodiment, the network device 120 may obtain the preference of BWP. For example, the network device 120 may obtain the identity of the BWP. The network device 120 may generate the configuration information indicating the BWP. In some embodiments, the network device 120 may downgrade the preferred BWP based on the radio resource availability. In this way, the power consumption can be saved.

In another embodiment, the network device 120 may obtain a paging cycle based on the assistant information and generate the preference of paging configuration comprising the paging cycle. In this way, the power consumption can be saved.

In some embodiments, the network device 120 may obtain a data rate of the terminal device 110-1 from the assistant information and generate the configuration information indicating the SPS. In this way, the SPS can be configured more suitable. For example, for the video surveillance of which data rate is fixed, the network device 120 may allocate radio resources based on the data rate. In this way, the dedicated radio bearer (DRB) can be configured more precisely.

In some embodiment, the network device 120 may obtain the mobility preference from the assistant information and generate the configuration information based on the assistant information. In some embodiments, the assistant information may indicate that the terminal device 110-1 is fixed. Alternatively or in addition, the assistant information may indicate the fixed location of the terminal device 110-1. In some embodiments, the assistant information may indicate that the terminal device 110-1 is the fast speed device. Alternatively or in addition, the assistant information may indicate the speed of the terminal device 110-1.

Only as an example, the network device 120 may determine the RNA configuration bases on the mobility preference. Before the terminal device 110-1 is changed from the RRC_CONNECTED to the RRC_IDLE, the network device 120 may determine a RNA list and transmit the RNA list to terminal device 110-1. If the assistant information indicates that the terminal device 110-1 is fixed, the network device 120 may generate one RNA list. If the assistant information indicates that the terminal device 110-1 is the fast speed device, the network device 120 may determine more than one RNA list since the terminal device 110-1 may need to connect with a plurality of network devices.

In some embodiments, the network device 120 may obtain the required number of SIBs from the assistant information. The network device 120 may generate the configuration information comprising the SIB. In an example embodiment, the network device 120 may obtain the type of the measurement event and the measurement parameters from the assistant information. The network device 120 may further generate the configuration information indicating the type of the measurement event and the measurement parameters.

In some embodiments, the network device 120 may obtain the traffic type of the terminal device 110-1 from the assistant information. Alternatively or in addition, the network device 120 may determine the MCS corresponding to the traffic type of the terminal device 110-1 based on the assistant information. In some embodiments, the network device 120 may obtain the MCS directly from the assistant information. The mapping information between the MCS and the traffic type may be pre-configured to the terminal device 110-1 and/or the network device 120. Alternatively or in addition, the mapping information between the data rate and the traffic type may be pre-configured to the terminal device 110-1 and/or the network device 120. The network device 120 may generate the configuration information indicating the MCS corresponding to the traffic type of the terminal device.

The network device 120 transmits 2040 the configuration information to the terminal device 110-1. The configuration information is used for communication between the terminal device 110-1 and the network device 120.

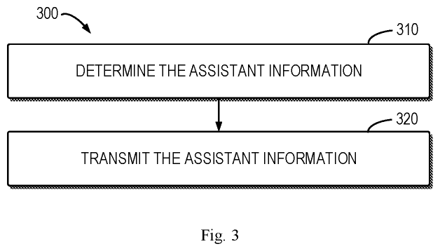

FIG. 3 shows a flowchart of an example method 300 in accordance with an embodiment of the present disclosure. The method 300 can be implemented at a terminal device 110-1 as shown in FIG. 1.

At block 310, the terminal device 110-1 determines the assistant information of the terminal device 110-1. The assistant information indicates one or more of a measurement of a reference signal, a preference of bandwidth part, a preference of paging configuration, a preference of inactive semi persistent scheduling, a preference of mobility, a preference of acquisition for system information block, a preference for measurement event, a traffic type of the terminal device.

In some embodiment, if the terminal device 110-1 is in the radio resource control (RRC)_Idle state, the terminal device 110-1 may perform measurements of the cell where the terminal device 110-1 locates. In some embodiments, the terminal device 110-1 may measure the RSRP. Alternatively or in addition, the terminal device 110-1 may measure the RSRQ. The terminal device 110-1 may generate the measurement of the reference signal comprising the RSRP and/or RSRQ. The measurement may be used by the network device 120 to identity the cell edge.

In an example embodiment, the terminal device 110-1 may be configured with more than BWP. The terminal device 110-1 may determine its preference of the BWP and generate the assistant information indicating the preference of the BWP. In some embodiments, the terminal device 110-1 may determine the BWP for uplink and/or downlink communication. In some embodiments, part of the legacy BWP can be indicated.

For example, the terminal device 110-1 may determine the identity of the BWP (for example, BWP 1) and generate the preference of the BWP indicating the identity. The terminal device 110-1 may report the preferred BWP identity in the assistant information as the activated BWP. In this way, the power of the terminal device can be saved.

In other embodiments, the terminal device 110-1 may determine its preferred paging configuration. In this way, the power of the terminal device can be saved. For example, the terminal device 110-1 may determine the paging cycle based on the power consumption of the terminal device 110-1. The terminal device 110-1 may generate the preference of paging configuration comprising the paging cycle. For example, the paging cycle may be one of rf32, rf64, rf128, rf256, rf512, rf1024, rf2048, or, rf4096.

In some embodiments, the terminal device 110-1 may determine a data rate of the terminal device 110-1 and generate the preference of inactive SPS comprising the data rate of the terminal device. In this way, the SPS can be configured more suitable. For example, for the video surveillance of which data rate is fixed, the terminal device 110-1 may report the assistant information indicating the data rate which can be used to allocate radio resources. In this way, the DRB can be configured more precisely.

In some embodiment, the terminal device 110-1 may determine the mobility preference and generate the assistant information indicating the mobility preference. If the terminal device 110-1 is a fixed location device, the terminal device 110-1 may generate the assistant information to indicate that the terminal device 110-1 is fixed. If the terminal device 110-1 is embedded with GNSS, the terminal device 110-1 may generate the assistant information indicating its fixed location. If the terminal device 110-1 is a fast speed device, the terminal device 110-1 may generate the assistant information to indicate that the terminal device 110-1 is the fast speed device. In addition, the terminal device 110-2 may generate the assistant information indicating its speed. The mobility preference may be used for determining RNA configuration. For example, if the terminal device 110-1 is fast moving, the terminal device 110-1 may obtain more than one RNA list from the network device 120. The terminal device 110-1 may connect with other network devices based on the RNA list. Details of configuring the RNA will be described later. In this way, the RNA can be configured precisely.

In some embodiments, the terminal device 110-1 may determine the number of SIB based on a type of the terminal device 110-1 and generate the preference of acquisition for the SIB comprising the required number of s SIBs. In some embodiments, new SIB is introduced for NR light. There may be multiple SIBs for multiple NR light devices type and the SIB size may be limited.

In some embodiments, the terminal device 110-1 may determine a uplink bit rate. The terminal device 110-1 may generate the assistant information indicating the preference of the uplink bit rate.

In an example embodiment, the terminal device 110-1 may determine a type of measurement event and determine measurement parameters for the type of measurement event. The terminal device 110-1 may generate the assistant information indicating the preference of measurement event configuration which comprises the type of the measurement event and the measurement parameters.

In some embodiments, the terminal device 110-1 may determine the traffic type of the terminal device 110-1 and determine a MCS corresponding to the traffic type of the terminal device 110-1. The terminal device 110-1 may generate the assistant information indicating the MCS and the traffic type. For example, the traffic type may be video surveillance, wearable devices and the like. The mapping information between the MCS and the traffic type may be pre-configured to the terminal device 110-1 and/or the network device 120. Alternatively or in addition, the mapping information between the data rate and the traffic type may be pre-configured to the terminal device 110-1 and/or the network device 120.

At block 320, the terminal device 110-1 transmits the assistant information to the network device 120. In some embodiments, if the assistant information is updated, the terminal device 110-1 may transmit the assistant information to the network device 120. For example, if the measured RSRP is changed, the terminal device 110-1 may update the assistant information and transmit the updated assistant information. In some embodiments, the assistant information may be transmitted in RRC signaling.

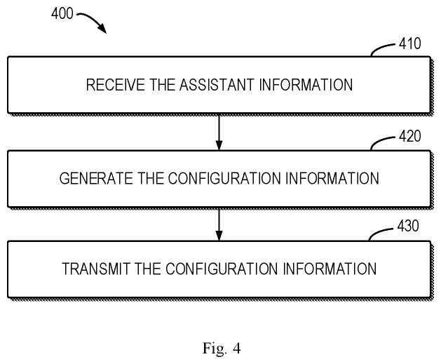

FIG. 4 shows a flowchart of an example method 400 in accordance with an embodiment of the present disclosure. Only for the purpose of illustrations, the method 400 can be implemented at a network device 120 as shown in FIG. 1.

At block 410, the network device 120 receives the assistant information from the terminal device 110-1. The assistant information indicates one or more of a measurement of a reference signal, a preference of bandwidth part, a preference of paging configuration, a preference of inactive semi persistent scheduling, a preference of mobility, a preference of acquisition for system information block, a preference for measurement event, a traffic type of the terminal device.

At block 420, the network device 120 generates the configuration information based on the assistant information. In some embodiments, the network device 120 may obtain the measurement of the reference signal from the assistant information. The measurement of the reference signal may comprise RSRP or RSRQ. The network device 120 may identify the cell edge based on the measurement of the reference signal. The network device 120 may generate the configuration information indicating the relay terminal device adjacent to the cell edge. For example, the network device 120 may configure the cell edge terminal device to be the relay terminal device.

In an example embodiment, the network device 120 may obtain the preference of BWP. For example, the network device 120 may obtain the identity of the BWP. The network device 120 may generate the configuration information indicating the BWP. In some embodiments, the network device 120 may downgrade the preferred BWP based on the radio resource availability. In this way, the power consumption can be saved.

In another embodiment, the network device 120 may obtain a paging cycle based on the assistant information and generate the preference of paging configuration comprising the paging cycle. In this way, the power consumption can be saved.

In some embodiments, the network device 120 may obtain a data rate of the terminal device 110-1 from the assistant information and generate the configuration information indicating the SPS. In this way, the SPS can be configured more suitable. For example, for the video surveillance of which data rate is fixed, the network device 120 may allocate radio resources based on the data rate. In this way, the dedicated radio bearer (DRB) can be configured more precisely.

In some embodiment, the network device 120 may obtain the mobility preference from the assistant information and generate the configuration information based on the assistant information. In some embodiments, the assistant information may indicate that the terminal device 110-1 is fixed. Alternatively or in addition, the assistant information may indicate the fixed location of the terminal device 110-1. In some embodiments, the assistant information may indicate that the terminal device 110-1 is the fast speed device. Alternatively or in addition, the assistant information may indicate the speed of the terminal device 110-1.

Only as an example, the network device 120 may determine the RNA configuration bases on the mobility preference. Before the terminal device 110-1 is changed from the RRC_CONNECTED to the RRC_IDLE, the network device 120 may determine a RNA list and transmit the RNA list to terminal device 110-1. If the assistant information indicates that the terminal device 110-1 is fixed, the network device 120 may generate one RNA list. If the assistant information indicates that the terminal device 110-1 is the fast speed device, the network device 120 may determine more than one RNA list since the terminal device 110-1 may need to connect with a plurality of network devices.

In some embodiments, the network device 120 may obtain the required number of SIBs from the assistant information. The network device 120 may generate the configuration information comprising the SIB. In an example embodiment, the network device 120 may obtain the type of the measurement event and the measurement parameters from the assistant information. The network device 120 may further generate the configuration information indicating the type of the measurement event and the measurement parameters.

In some embodiments, the network device 120 may obtain the traffic type of the terminal device 110-1 from the assistant information. Alternatively or in addition, the network device 120 may determine the MCS corresponding to the traffic type of the terminal device 110-1 based on the assistant information. In some embodiments, the network device 120 may obtain the MCS directly from the assistant information. The mapping information between the MCS and the traffic type may be pre-configured to the terminal device 110-1 and/or the network device 120. Alternatively or in addition, the mapping information between the data rate and the traffic type may be pre-configured to the terminal device 110-1 and/or the network device 120. The network device 120 may generate the configuration information indicating the MCS corresponding to the traffic type of the terminal device.

At block 430, the network device 120 transmits the configuration information to the terminal device 110-1. The configuration information is used for communication between the terminal device 110-1 and the network device 120.

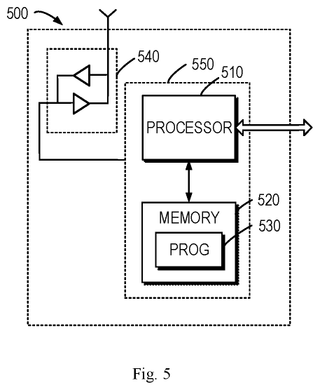

FIG. 5 is a simplified block diagram of a device 500 that is suitable for implementing embodiments of the present disclosure. The device 500 can be considered as a further example implementation of the terminal device 110, the network device 120, the network device 130, or the transition network device 310 as shown in FIG. 1 and FIG. 3. Accordingly, the device 500 can be implemented at or as at least a part of the terminal device 110, the network device 120, the network device 130, or the transition network device 310.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 520 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2 interface for bidirectional communications between eNBs, Si interface for communication between a Mobility Management Entity (MME)/Serving Gateway (S-GW) and the eNB, Un interface for communication between the eNB and a relay node (RN), or Uu interface for communication between the eNB and a terminal device.

The program 530 is assumed to include program instructions that, when executed by the associated processor 510, enable the device 500 to operate in accordance with the embodiments of the present disclosure, as discussed herein with reference to FIG. 2 and FIGS. 4 to 5. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 850 adapted to implement various embodiments of the present disclosure.

The memory 520 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2-4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-44. (canceled)

45. A method performed by a terminal device, comprising:
determining a preference on bandwidth related information for power saving; and
transmitting assistance information to provide the preference on bandwidth related information for power saving.

46. The method of claim 45, further comprising:
transmitting assistance information to provide the preference on the bandwidth related information for power saving, when the preference on the bandwidth related information for power saving is updated.

47. The method of claim 45, further comprising:
determining a preference on mobility state; and
transmitting assistance information to provide the preference on mobility state.

48. The method of claim 47, wherein the mobility state indicates that the terminal device is fixed.

49. The method of claim 45, further comprising:
determining information on measurement event; and
transmitting assistance information to provide the information on measurement event.

50. A terminal device comprising a processor configured to:
determine a preference on bandwidth related information for power saving; and
transmit assistance information to provide the preference on bandwidth related information for power saving.

51. The terminal device of claim 50, wherein the processor is further configured to:
transmit assistance information to provide the preference on the bandwidth related information for power saving, when the preference on the bandwidth related information for power saving is updated.

52. The terminal device of claim 50, wherein the processor is further configured to:
determine a preference on mobility state; and
transmit assistance information to provide the preference on mobility state.

53. The terminal device of claim 52, wherein the mobility state indicates that the terminal device is fixed.

54. The terminal device of claim 50, wherein the processor is further configured to:
determine information on measurement event; and
transmit assistance information to provide the information on measurement event.
